(19) United States
(12) Patent Application Publication
(10) Pub. No.: US 2008/0161027 A1
(43) Pub. Date: Jul. 3, 2008

(54) Active messaging that triggers future reminders

(75) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/647,727

(22) Filed: Dec. 29, 2006

(51) Int. Cl. H04Q 7/20

(52) U.S. Cl. 455/466

(57) ABSTRACT

A method of providing an appointment reminder includes: creating an appointment reminder message; sending the appoint reminder message from a first device of a first party to a second device of a second party; receiving the appointment reminder message at the second device at a first point in time; storing the appointment reminder message in the second device; and, activating the appointment reminder message stored in the second device at a second point in time after the first point in time.

### FIELD

The present inventive subject matter relates to the telecommunication arts. Particular application is found in conjunction with mobile telephones and/or wireless telecommunication networks, and the specification makes particular reference thereto. However, it is to be appreciated that aspects of the present inventive subject matter are also amenable to other like applications and/or networks.

### BACKGROUND

Many places of business have employees or other personnel that manually place telephone calls to individuals to remind them in advance of scheduled appointments. For example, often medical facilities, dental offices, hair salons and the like call patients and/or clients prior to their scheduled appointments to remind them of their scheduled appointments. However, manually making appointment reminder telephone calls can be time consuming and/or an inefficient use of personnel. Additionally, the making or setting of appointments can at times be done many days in advance of the actual scheduled appointment. For the telephone calls to serve as useful reminders for the recipients, typically, the calls are placed at or near the time of the appointments, e.g., the day before. Accordingly, the place of business or other entity making the reminder telephone calls has to remember or otherwise keep track of when the appointments are and wait to make the corresponding reminder telephone calls at some later time, i.e., some suitably short time before the appointments. Such an approach involves performing two separate tasks, i.e., 1) making or setting the appointment, and 2) making the reminder call. As can be appreciated, the foregoing approach is accompanied by the typical inefficiency associated with performing multiple separate tasks. The relative inefficiency is particularly undesirable, especially, if the execution of a single task could achieve the same functions.

SMS (Short Message Service) messaging is generally known in the art. In a typical telecommunications network, e.g., a wireless network, SMS permits text messages to be sent to an SMS enabled mobile station (MS). Traditional SMS may be used to send appointment reminders to individuals in text messages. However, the conventional use of SMS messaging to send reminders is still a manual process. Moreover, there is still the issue that the SMS reminder messages still have to be sent at or near the time of the appointment if they are to effectively serve as a reminder for the recipient. That is to say, if the recipient receives the SMS message long before the scheduled appointment, there is a greater likelihood that in the intervening time they may still forget about the appointment. Accordingly, even with the use of traditional SMS messaging, sending a text message reminder is still a separate manual task that typically has to be performed at some later time after an appointment is made or set.

Accordingly, a new and improved method and/or system for sending and/or receiving active messages that trigger future reminders is disclosed that overcomes the above-referenced problems and others.

### SUMMARY

In accordance with one embodiment, a method of providing an appointment reminder includes: creating an appointment reminder message; sending the appoint reminder message from a first device of a first party to a second device of a second party; receiving the appointment reminder message at the second device at a first point in time; storing the appointment reminder message in the second device; and, activating the appointment reminder message stored in the second device at a second point in time after the first point in time.

In accordance with another embodiment, a system of providing an appointment reminder includes: creating means for creating an appointment reminder message; sending means for sending the appointment reminder message from the creating means to a receiving means for receiving the appointment reminder message at a first point in time; storing means for storing the appointment reminder message received by the receiving means; and, activating means for activating the appointment reminder message stored in the storing means at a second point in time after the first point in time.

In accordance with yet another embodiment, a method of providing an appointment reminder includes: creating a message in an e-mail format, the message including appointment information; providing in the message an indicator that identifies the message as an appointment reminder, and triggering data that determines when the appointment reminder is to be activated; sending the message from a first device; converting the message from the e-mail format to a short message service format; receiving the message in the short message service format at a second device at a first point in time, the second device examining the indicator included in the message to determine that the message is an appointment reminder; storing the appointment reminder in the second device; and, activating the appointment reminder in the second device at a second point in time after the first point in time, the activating occurring in accordance with the triggering data included in the associated message.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

As described above, on occasion, a business or other entity (generally referred to herein nominally as the first party) may wish to make or otherwise set appointments with and provide reminders of these appointments to clients or other individuals (generally referred to herein nominally as the second party) for whom the appointment was scheduled. Often, to maximize the effectiveness of the reminder, it is desired that the reminder alert or otherwise notify its recipient (i.e., the second party) of the scheduled appointment at or near the time of the appointment, e.g., within some suitably short period of time before the scheduled appointment. However, the appointment may be scheduled for several days, weeks, months or even longer after the appointment is originally made or set. Suitably, the reminder should alert or notify the second party of the appointment, e.g., a day in advance or several hours in advance or some other suitably short period of time in advance. Nevertheless, to maximize efficiency, the first party may desire to combine the operations of making the appointment and producing the reminder into a common task. Accordingly, the present inventive subject matter described herein has been developed, whereby at or near the time that the appointment is being made or otherwise set, the first party produces and/or sends (e.g., using a specialized and/or enhanced e-mail client or other like application or system) an appointment reminder message (ARM) to a mobile station (MS) or other suitable SMS-enabled end user device of the second party. In an exemplary embodiment, however, the receipt of the ARM by the MS does not trigger the MS to alert and/or otherwise behave in the usual manner. Rather, the MS recognizes the ARM for what it is, and merely stores it (e.g., in a dormant or otherwise inactive state) until such future time as the reminder is set in the ARM to go off or otherwise activate. At that time, the MS is triggered to ring or alert and/or otherwise behave as if the ARM had just been received by the MS. In this manner, the ARM is produced and sent at or near the time the appointment is originally made, and at a future time the ARM is activated on the second party's device to remind the second party of the scheduled appointment.

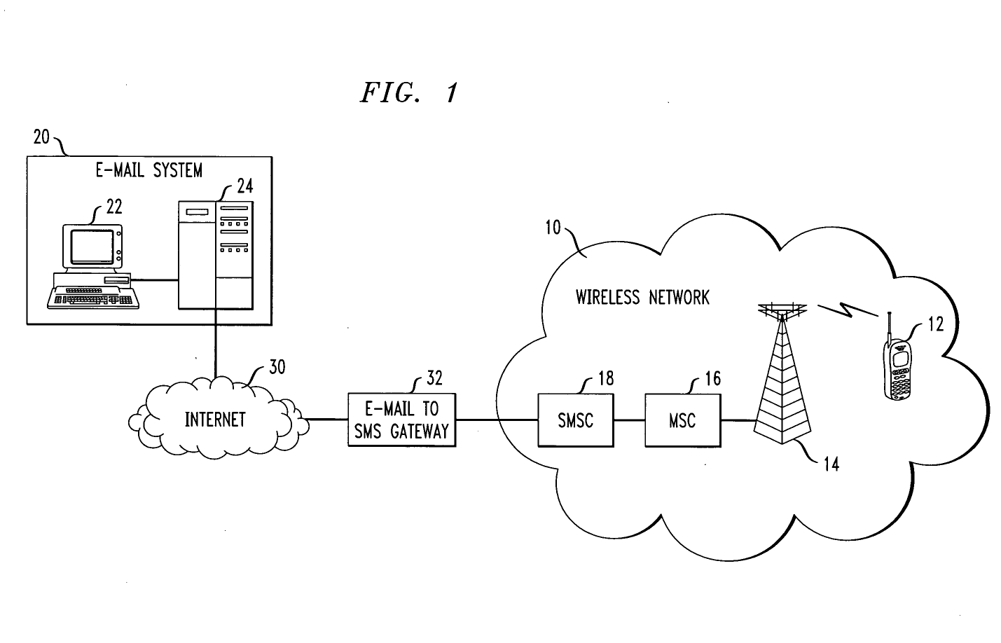

With reference to FIG. 1, a wireless telecommunications network 10 serves a mobile device or MS 12 (e.g., a mobile telephone or other wireless mobile end user equipment) used by the second party to receive the ARM from the first party, e.g., in an SMS or other like format. Suitably, the MS 12 is optionally provisioned with one or more of the usual elements, e.g., a keypad with traditional numeric keys, soft-keys, navigation keys, etc.; a microphone and speaker; a liquid crystal display (LCD) or other such display; a memory and/or other data storage device; a CPU (Central Processing Unit) or other controller; an operating system and/or other software; a clock and/or a calendar; a SIM (Subscriber Identity Module) or other smart card; a ringer, a vibrator and/or other altering function and/or equipment; and, other components commonly found on and/or incorporated in a MS.

Selectively, the MS 12 connects with a wireless telecommunications network via a base station (BS) 14 served by a mobile switching center (MSC) 16. More specifically, the MSC 16 is operatively connected to and/or in communication with a plurality of base stations (one of which is shown as BS 14) in the usual manner. As is understood in the art, each BS provides an over-the-air radio frequency interface for its respective geographic area or cell. Selectively, the MS 12 is provided telecommunication services and/or otherwise accesses the network 12 via the interface and/or the BS serving the cell in which the MS 12 is located, e.g., as shown in this example the MS 12 is located in the cell served by the BS 14.

In a suitable embodiment, the MS 12 is SMS-enabled. That is to say, the MS 12 is equipped and/or otherwise provisioned to receive, send, process, store, display and/or otherwise handle and/or manage SMS messages. For simplicity and clarity, SMS is generally referred to herein. However, it is to be understood that when referring to SMS herein, it is intended to encompass not only SMS but also EMS (Enhanced Message Service), MMS (Multimedia Message Service) and other like message services. As shown in FIG. 1, SMS messages addressed to or otherwise intended for the MS 12, are routed thereto through an SMS Center (SMSC) 18 which is operatively connected to and/or in communication with the MSC 16 in any conventional manner. Suitably, the SMSC 18 collects and distributes SMS messages for the MS 12 in the usual fashion.

Also shown in FIG. 1 is an e-mail system 20 or other like system that the first party uses to generate and send the ARM to the second party. Suitably, the e-mail system 20 includes: a workstation or computer 22 or other like device that supports and/or has running thereon an e-mail client or other like application for creating and sending e-mails; and, an e-mail server 24 that is equipped and/or otherwise provisioned to route the e-mails generated at the computer 22 over a data network 30, e.g., such as the Internet. As is understood in the art, the computer 22 is operatively connected to and/or in communication with the e-mail server 24 in any of a variety of conventional manners, and the e-mail server 24 is in turn operatively connected to and/or in communication with the data network 30 in any of a variety of conventional manners.

In a suitable embodiment, the first party employs the e-mail client running on the computer 22 to create and sent the ARM to the second party at or near the time an appointment is made or set. For example, the e-mail is addressed to the MS 12 of the second party by entering the telephone number of the MS 12 in a “To:” line or other suitable field along with the identity of an e-mail to SMS gateway 32. For example, the address may take the form “2165551234@abcgateway.com,” wherein 2165551234 represents the telephone number of the MS 12 and abcgateway.com represents the identity of the gateway 32. The gateway 32 is optionally any suitable gateway as is known in the art for bridging messages from an e-mail protocol environment to an SMS protocol environment. That is to say, the gateway 32 bridges the data network 30 with the wireless network 10. Suitably, the gateway 32 serves to translate or otherwise convert the ARM from an e-mail message format to an SMS message format, and direct the ARM to the appropriate SMSC 18 serving the MS 12.

Suitably, in the body and/or subject line of the e-mail or other appropriate location, the first party enters or otherwise inputs the relevant appointment information, e.g., such as the date and/or time of the appointment, the location of the appointment, etc. When the e-mail is being created with the e-mail client on the computer 22, the first party also indicates that the e-mail is in fact an ARM that is to be specially handled, i.e., unlike conventional messages. For example, a flag or other indicator in the header or elsewhere is set to identify the message as an ARM that is to receive special handling by the MS 12. Optionally, the e-mail client running on the computer 22 is provisioned to provide a radio button or check box or the like which the first party may optionally select to indicate that the e-mail being created is in fact a specialized ARM. In addition, the first party designates, selects or otherwise sets a date and/or time at which the ARM is to be activated, i.e., a future date and/or time when the reminder is to be triggered. For example, the first party may select a particular date and/or time, or alternately, the first party may choose a particular amount of time prior to the scheduled appointment, e.g., a number of days in advance of the scheduled appointment, a number of hours, etc. Moreover, optionally, a plurality of designations may be selected or set so that the reminder is triggered a plurality of times. Of course, in the absence of one or more specific choices or settings being entered or otherwise input by the first party, a default value is optionally employed.

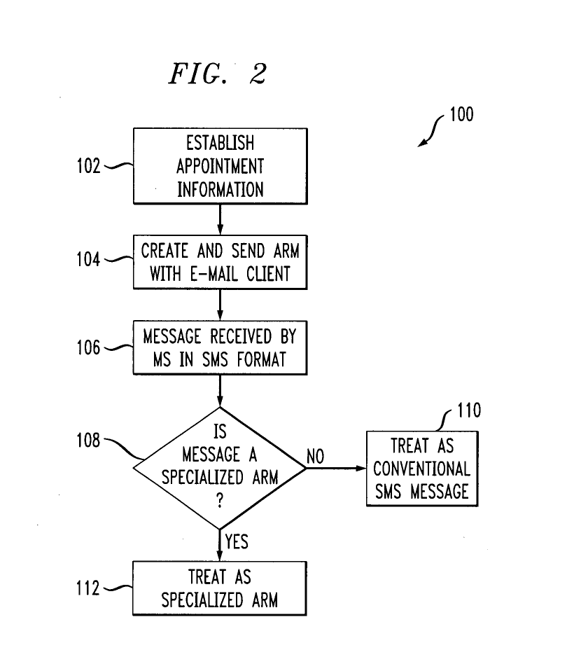

With reference to FIG. 2, a exemplary method or process 100 which is suitable for practicing aspects of the present inventive subject matter is shown. At step 102, the first party obtains or otherwise establishes the appointment information. For example, the first party and the second party may agree upon a time, date, location and/or other relevant details for the appointment being scheduled. Additionally, the first party may obtain from the second party a telephone number for the MS 12. At step 104, which optionally occurs concurrently with or near the time of step 102, the first party creates and sends the specialized ARM, e.g., as described above. More specifically, once the specialized ARM has been created with the e-mail client on the computer 22, it is sent. The ARM is routed, sent or otherwise forwarded by the e-mail server 24 over the data network 30 to the gateway 32. The gateway 32 in turn translates the ARM into SMS format and routes, sends or otherwise forwards it to the SMSC 18. In the usual fashion, the SMSC 18 then delivers or otherwise forwards the ARM to the MS 12 over the wireless network 10, e.g., via the MSC 16 and BS 14 serving the MS 12.

At step 106, the specialized ARM in SMS format is received by the MS 12. At decision step 108, the MS 12 determines if the received SMS is a specialized ARM. Suitably, the MS 12 checks the header information to make this determination. For example, the MS 12 looks at the header information to determine if the aforementioned flag or other indicator has been set to identify the message as a specialized ARM. If the flag or indicator has not been set, then the process 100 branches to step 110 and the message is treated as a normal SMS message, i.e., it is not a specialized ARM and accordingly it is handled in the usual manner as a conventional SMS message. Alternately, if the flag or indicator has been set, then the process 100 continues to step 112 where the specialized ARM is handled by the MS 12.

Suitably, the MS 12 is equipped or otherwise provisioned with an application or other software to administer the ARM. Optionally, when a message identified as a ARM is received by the MS 12, it is received silently, i.e., without the alerting function of the MS 12 being triggered. Each ARM received by the MS 12 is then stored in the MS 12 in a dormant or inactive state. For example, the contents of the message (i.e., appointment information), the sender's address or telephone number, the triggering information indicating when the reminder should be activated, etc. are stored, e.g., in a memory within the MS 12. Periodically, the stored ARMs are checked to determine if it is time to activate them. For example, if the triggering information matches the current time and/or date or is past due or is otherwise within some threshold proximity thereof, then the ARM is activated. When an ARM is activated, the alerting function of the MS 12 is triggered thereby reminding the second party of the scheduled appointment. Suitably, the message may also be displayed on the MS 12 and/or the MS 12 may otherwise act or behave as if the ARM had just been received thereby. Optionally, the second party may return a confirmation SMS message or telephone call to the sender (i.e., the first party), e.g., with a simple selection of a soft-key or suitable operation. In an alternate embodiment, if the MS 12 is provisioned with a calendar application such as is commonly available, the MS 12 may enter the scheduled appointment information from the ARM into the calendar and set the appropriate reminder in accordance with the information contained in the specialized ARM.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of providing an appointment reminder, said method comprising:
(a) creating an appointment reminder message;
(b) sending the appoint reminder message from a first device of a first party to a second device of a second party;
(c) receiving the appointment reminder message at the second device at a first point in time;
(d) storing the appointment reminder message in the second device; and,
(e) activating the appointment reminder message stored in the second device at a second point in time after the first point in time.

2. The method of claim 1, wherein said second device is a mobile station served by a wireless telecommunications network.

3. The method of claim 2, wherein step (e) comprises:
triggering an alerting function of the mobile station.

4. The method of claim 3, wherein said alerting function of the mobile station is not triggered when the appointment reminder message is received by the mobile station.

5. The method of claim 4, wherein step (e) further comprises:
displaying the appointment reminder message on the mobile station.

6. The method of claim 1, wherein the appointment reminder message is in an e-mail format when it is created.

7. The method of claim 6, further comprising:
converting the appointment reminder message to a short message service format prior to step (c).

8. A system of providing an appointment reminder, said system comprising:
creating means for creating an appointment reminder message;
sending means for sending the appoint reminder message from the creating means to a receiving means for receiving the appointment reminder message at a first point in time;
storing means for storing the appointment reminder message received by the receiving means; and,
activating means for activating the appointment reminder message stored in the storing means at a second point in time after the first point in time.

9. The system of claim 8, wherein said receiving means is a mobile station served by a wireless telecommunications network, and said storing means are incorporated in said mobile station.

10. The system of claim 9, wherein activation of the appointment reminder message triggers an alerting function of the mobile station.

11. The system of claim 10, wherein said alerting function of the mobile station is not triggered when the appointment reminder message is received by the mobile station.

12. The system of claim 11, wherein mobile station includes display means for displaying the appointment reminder message on the mobile station when the appointment reminder message is activated.

13. The system of claim 8, wherein the creating means includes an e-mail client running on a computer, and the appointment reminder message is in an e-mail format when it is created.

14. The system of claim 13, further comprising:
converting means for converting the appointment reminder message to a short message service format prior to it being received by the receiving means.

15. A method of providing an appointment reminder, said method comprising:
(a) creating a message in an e-mail format, said message including appointment information;
(b) providing in the message an indicator that identifies the message as an appointment reminder, and triggering data that determines when the appointment reminder is to be activated
(c) sending the message from a first device;
(d) converting the message from the e-mail format to a short message service format;
(e) receiving the message in the short message service format at a second device at a first point in time, said second device examining the indicator included in the message to determine that the message is an appointment reminder;
(f) storing the appointment reminder in the second device; and,
(g) activating the appointment reminder in the second device at a second point in time after the first point in time, said activating occurring in accordance with the triggering data included in the associated message.
